(19) United States
(12) Patent Application Publication
(10) Pub. No.: US 2005/0034159 A1
(43) Pub. Date: Feb. 10, 2005

(54) Implementing a hybrid wireless and coaxial cable network

(75) Inventors: Lior Ophir, Herzlia (IL); Yigal Bitran, Tel Aviv (IL)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/935,963

(22) Filed: Sep. 7, 2004

Related U.S. Application Data
(63) Continuation-in-part of application No. 10/740,312, filed on Dec. 18, 2003.
(60) Provisional application No. 60/435,575, filed on Dec. 20, 2002.

(51) Int. Cl. H04N 7/18

(52) U.S. Cl. 725/78; 725/74; 725/81; 725/85

(57) ABSTRACT

A home video network, and a home video and data network, utilizing wireless protocol communications over coaxial cable (CX) are disclosed. In the home video network, a main network station (10) includes video processing functionality, such as one or more of a DVD player, personal video recorder (PVR), and a set-top box (STB) for cable or satellite television reception. The main network station (10) also includes a matched splitter (27) that receives coaxial cable (CX) inputs, and provides low-pass filtered and high-pass filtered output. The low-pass filtered output (LF) corresponding to video signals is provided to the video processing functionality (20) and the high-pass filtered output (HF) corresponding to wireless protocol communications is provided to a wireless access point function (22). Other network stations and combinations of functions are also disclosed, including those that utilize a function switch (25) to switch between network communications over coaxial cable (CX) and communications over an antenna (A), in either a single BSS mode or a double BSS mode.

### CROSS-REFERENCE TO RELATED APPLICATIONS

This application is a continuation-in-part of copending application Ser. No. 10/740,312, filed Dec. 18, 2003, which in turn claims priority of provisional application No. 60/435,575, filed Dec. 20, 2002.

### STATEMENT REGARDING FEDERALLY SPONSORED RESEARCH OR DEVELOPMENT

Not applicable.

### BACKGROUND OF THE INVENTION

This invention is in the field of local area networks, and is more specifically directed to network communications over both wireless links and coaxial cable.

As is fundamental in the art, broadband Internet access is continuing to be deployed to homes across the nation and around the world. As a result, many consumers are realizing that the high data rate Internet access provided by broadband Internet access can be readily shared among multiple personal computers over a home network. In addition, the various service providers, including cable television providers, telephone companies, satellite broadcasters, and the like, are now beginning to each deploy a wide range of services over the same facility to the home. These multiple services include data services (i.e., Internet access, local file and printer sharing), Voice over Internet Protocol (VoIP) telephony, television and pay-per-view content. The service providers, regardless of the technology used to deliver these multiple services to the home, rely on home networking to deliver these services to not only the personal computers in the home, but also to other devices such as televisions, set-top boxes, a digital video recorder (i.e., “personal” video recorder or “PVR”), telephone equipment, game systems, audio systems, and the like.

Still other services and functionality to be provided by home networks are now being contemplated by service providers. These services include home device control (heater, air conditioning, kitchen appliance control), security systems including networked cameras and sensors, and gaming applications. It is contemplated that each of these services can be provided over the same home network with television, data communications, and VoIP telephony, assuming that high enough data rates can be carried over the network.

Of course, it is relatively simple and inexpensive to install home network wiring, such as Ethernet cabling, into homes that are being newly constructed. But the widespread deployment of these services in the marketplace require the installation of home networks into existing homes. The post-construction installation of Ethernet cabling into many rooms of an existing home can be an expensive and inconvenient undertaking.

As a result, various technologies have been proposed to implement home networking into existing homes, using the facilities that are already present. Examples of these conventional technologies include the HomePNA networking technology, which uses existing telephone wiring to various rooms in a home as the networking medium, and the HomePlug powerline network technology, which uses the existing 110 volt home electrical wiring as the networking medium for communications among the rooms of the home. These technologies have had only limited success in the marketplace, however, for various reasons.

Another technology for implementing a home network over existing home wiring is referred to as the HomeCN network, which uses the existing coaxial cable used for cable television delivery throughout the home as the home network medium. Copending and commonly assigned U.S. patent application Ser. No. 09/548,048 filed Apr. 12, 2000, and copending and commonly assigned U.S. patent application Ser. No. 09/636,019 filed Aug. 10, 2000, both incorporated herein by this reference, describe examples of this home networking technology.

Of course, wireless local area network (WLAN) technology has become very popular as a LAN technology for both office and home networks, and also pay-as-you-go access at coffee shops, airports, hotels, and the like. The popularity of wireless LAN networking is due in large part to the IEEE 802.11a/b/g standards for wireless data communications, which have been adopted by many network equipment manufacturers, resulting in excellent compatibility in the marketplace. The IEEE 802.11 standards specify the operation of wireless communications in the 2.4 GHz bandwidth space and the 5 GHz bandwidth space. The wireless LAN technology has developed into a high-speed yet low-cost networking solutions, with many personal computers (especially laptop, or portable, computers) now including 802.11 wireless connectivity as a standard feature.

With raw data rates of 11 Mbps and ranges of 300 to 500 feet in free space, the 802.11b wireless communication standard offers a very good solution for the sharing of a broadband connection over multiple computers in the home. The newer services being deployed over home networks can be more readily supported by the higher data rate standards 802.11 g/a, which provide data rates of up to 54 Mbps. The 802.11e and 802.11i standards address the growing need for Quality of Service (QoS) and security, respectively.

However, current wireless LAN devices are often not capable of providing high data rate communications over an entire home. The 11 Mbps data rate of 802.11b wireless LANs of course limits its ability to support bandwidth intensive services such as video distribution, While the 54 Mbps data rate provided by the 802.11a/g standards is theoretically adequate for handling multiple video streams communicated within the home network, the wireless signal range at this data rate cannot be guaranteed throughout many homes. For example, the attenuating effects of walls, fireplaces, flooring (in multi-story homes), and other structures of the home severely impact the available data rate and signal range. In addition, the router of the home network is often located near the exterior wall of the home at which the incoming facility (e.g., cable television input) enters the home; if this router is also the wireless access point of the network, rooms at the opposite end of the house can be outside of the useful wireless signal range. The effects of time-varying multipath propagation, and the ever-changing mix of stations and payload over the network, further reduce the available datarate over the wireless home network. Typically, this inadequacy requires the homeowner to again consider installing network wiring, whether to reach a computer located at a far end of the home, or to provide a more centrally located wireless access point. But the need to install additional network wiring, of course, somewhat defeats the reason for using wireless technology for home networking to begin with.

Copending application Ser. No. 10/740,312, filed Dec. 18, 2003, through which this application claims priority, commonly assigned with this application and incorporated herein by this reference, describes a hybrid coaxial and wireless home network, in which wireless protocol communications are carried over both wireless links and also coaxial cabling in the home network.

### BRIEF SUMMARY OF THE INVENTION

It is therefore an object of this invention to provide a home networking technology that minimizes the installation of network cabling, while still providing coverage of an entire home.

It is a further object of this invention to provide such a technology in which sufficiently high data rates can be carried so that a wide range of services can be deployed throughout a home installation.

It is a further object of this invention to provide such a technology in which the resulting home network is compatible with a wide range of communications services, including data communications, video and audio content delivery, gaming, control and security applications, VoIP telephony, and the like.

It is a further object of this invention to provide such a technology in which the deployment cost of the home network is relatively modest.

Other objects and advantages of this invention will be apparent to those of ordinary skill in the art having reference to the following specification together with its drawings.

The present invention may be implemented into a home video network technology in which video signals, such as television or digital video, and data signals from an external source (e.g., the Internet) and also local data communications over the network, are communicated according to a wireless transmission protocol and standard over coaxial cable, individually or in combination with a wireless link. Network stations in this hybrid home network can include both coaxial and wireless capability.

According to another aspect of the invention, a main network station including a source of video data, such as a DVD, PVR, or a set-top box, and a wireless communication access point function, is provided, together with a matched splitter for receiving incoming video and low frequency data channels, and also data channels in a wireless communications protocol. A function switch is provided to enable wireless communication capability for the station.

According to another aspect of the invention, a residential gateway including a modem function for handling data communications with an external network (e.g., the Internet), and a wireless communication access point function, is provided, together with a matched splitter for receiving incoming video and low frequency data channels, and also data channels in a wireless communications protocol. A function switch is provided to enable wireless communication capability for the station.

According to another aspect of the invention, a client network station including a wireless communication access point function and matched splitter is provided. According to another aspect of the invention, a wireless repeater or extender including a wireless communication access point function and matched splitter is provided.

According to another aspect of the invention, a matched splitter is provided, for example within each network element that resides on the coaxial network. The matched splitter is capable of splitting incoming network communications from incoming CATV signals, and providing the separate communications over separate paths. The matched splitter matches the impedances of the facilities with which it communicates, reducing attenuation and reflection loss in the splitter. The matched splitter may be incorporated into a network station, or may constitute an upgrade device that connects to existing wireless network equipment to provide wireless over coaxial communications capability.

### BRIEF DESCRIPTION OF THE SEVERAL VIEWS OF THE DRAWING

FIG. 1 is an electrical diagram, in block form, of a home video network constructed according to the preferred embodiments of the invention.

FIGS. 2a through 2c are electrical diagrams, in block form, of 802.11 over coaxial network elements according to various preferred embodiments of the invention.

FIGS. 3a and 3b are electrical diagrams, in block form, of filtering elements incorporated into a home network according to preferred embodiments of the invention.

FIGS. 4a through 4d are electrical diagrams, in block form, of home data networks constructed according to preferred embodiments of the invention.

FIGS. 5a through 5d are electrical diagrams, in block form, of 802.11 over coaxial network elements according to various preferred embodiments of the invention.

FIGS. 6a through 6c are electrical diagrams, in block form, of an upgrade kit and its installation in connection with network devices, according to preferred embodiments of the invention.

### DETAILED DESCRIPTION OF THE INVENTION

The present invention will be described in connection with its preferred embodiment, namely as implemented into home video and data networks utilizing existing wiring, because it is contemplated that this invention will be especially beneficial when utilized in such an application. Specifically, this invention is particularly beneficial for implementation of a home video network, and also a home video and data network, as will be described below. However, it is contemplated that this invention will also be useful and beneficial when applied in other alternative network arrangements, and according to alternative specific realizations. Accordingly, it is to be understood that the following description is provided by way of example only, and is not intended to limit the true scope of this invention as claimed.

Home Video Network

According to a first preferred embodiment of the invention, a home video network can be easily configured and realized using the existing coaxial cable installed in a home, as used for receipt of cable television or satellite television content. According to this embodiment of the invention, content can be routed from a DVD or PVR to one or more other television sets or monitors located elsewhere in the home, and digital video or digital still pictures can be routed from a multimedia home computer to other television sets or monitors elsewhere in the home.

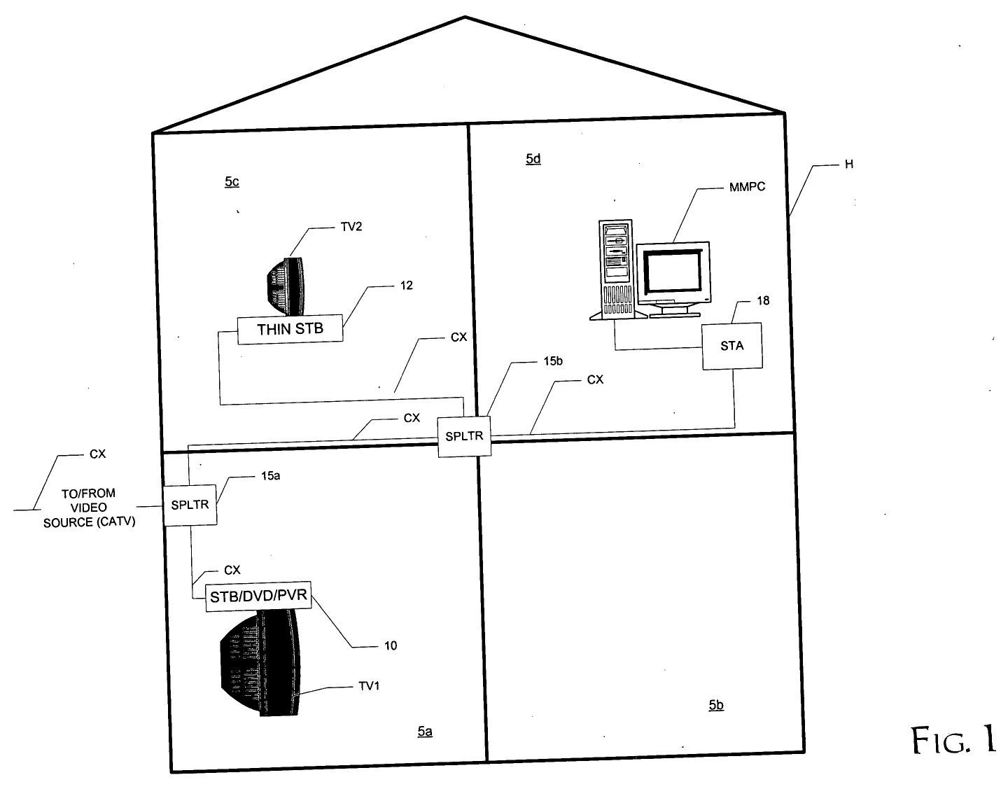

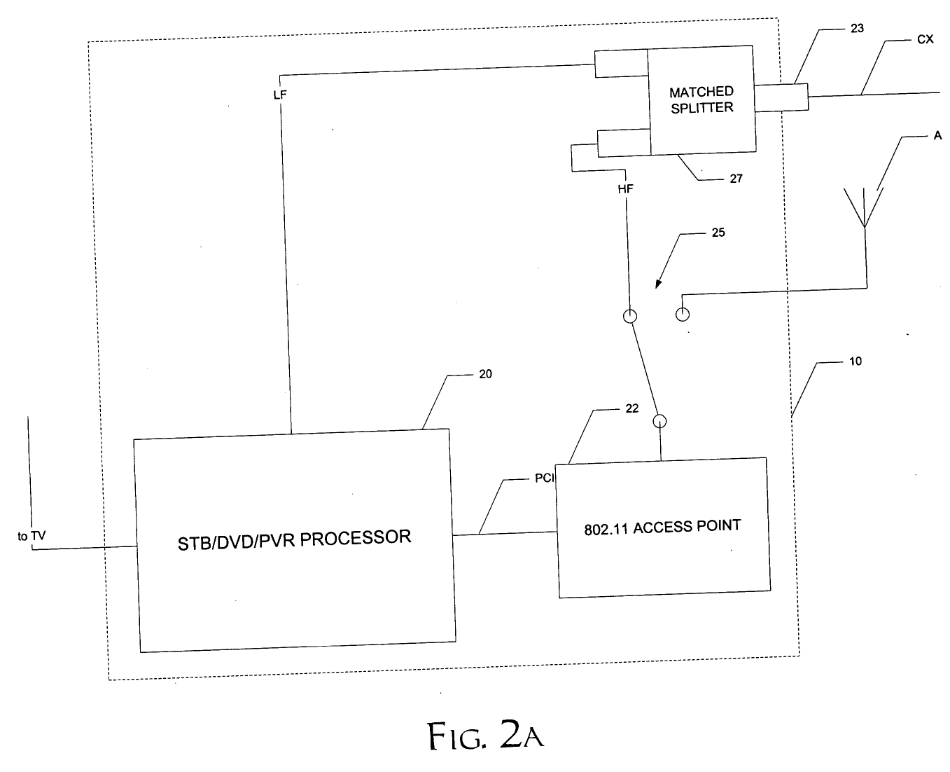

FIG. 1 illustrates an exemplary home video network, itself and its components constructed according to the preferred embodiment of the invention. As is well-known in this art, the particular configuration of any given network depends upon the network elements involved, the structure and location of the various network elements, the types of connections desired, the number of users to be supported, and the like. Modern network equipment typically provides a great deal of flexibility to the network installer and users. As a result, the arrangement of home networks can vary widely. This particular home network installation shown in FIG. 1 is therefore presented by way of example only.

In the example of FIG. 1, home splitter 15a connects the home to an external video source. This video source may be a cable television provider. In this case, home splitter will have, or be coupled to, a coaxial cable connector in order to connect to the cable television provider. Alternatively, the video source may be a satellite dish mounted to the home or nearby, by way of which television signals would be communicated from and to a satellite data and television provider, via a satellite in geosynchronous orbit, as well known in the art. Still further in the alternative, the video source may be a digital subscriber line (DSL) service provider, which is providing television programming over conventional telephone lines (typically a combination of fiber optic and twisted-pair facilities), in which case a DSL router (with or without wireless LAN capability) receives the DSL content and routes the video content by way of coaxial cable to home splitter 15a.

Home splitter 15a is a conventional cable television splitter, connected on one side to the incoming cable coupled to the video source, and coupled on another side to one or more network elements within the home over coaxial cable CX according to this embodiment of the invention. It is contemplated that coaxial cable CX can refer to coaxial cable that was already installed and present within the home at the time that the home video network shown in FIG. 1 was arranged; this pre-existing coaxial cable CX would have been installed to provide cable television signals throughout the home. The preferred embodiment of this invention is especially beneficial in this event, as it is capable of establishing a high data-rate home video network without requiring new cabling to be installed. Of course, some or all of coaxial cable CX may be installed specifically in connection with the network deployment, as necessary or desirable.

In this example, main network station 10 is located in room 5a, and is connected to home splitter 15a by way of coaxial cable CX. Main network station 10 is associated with television set TV1, and in this example constitutes one or more of the functions of a set-top box (STB) for tuning and receiving digital television programming, personal video recorder (PVR) for recording digital television programming and distributing it to television set TV1 in the conventional manner. According to this embodiment of the invention, these signals may also be communicated to other television sets and stations on the network using a wireless communications protocol, such as those according to the 802.11 standards (i.e., 802.11a, 802.11b, or 802.11g).

In the exemplary home network installation shown in FIG. 1, home splitter 15a is also connected to downstream home splitter 15b, by way of coaxial cable CX. Home splitter 15b, which is also a conventional cable television splitter, is in turn connected to client network station 12, which in this example is a “thin” set-top box coupled to television set TV2, located in upstairs room 5c. Home splitter 15b is also connected to multimedia workstation MMPC in upstairs room 5d, also by way of coaxial cable CX and network station 18. Workstation MMPC may have additional functions, such as distributing audio signals throughout the home. As described in further detail below, multimedia workstation MMPC is capable of distributing digital video signals to television sets TV1, TV2.

In operation, the network communications within the home video network of FIG. 1 are preferably packet-based communications, with these packets corresponding to a wireless communication standard, such as the 802.11 protocol, but communicated over coaxial cable CX.

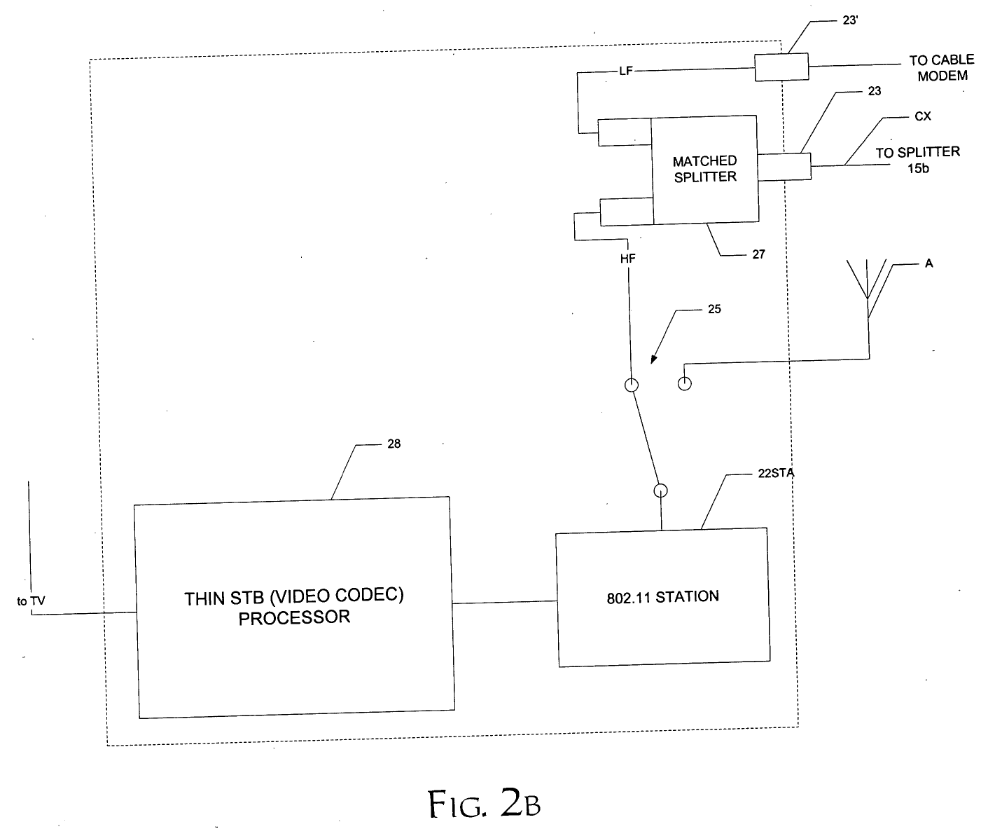

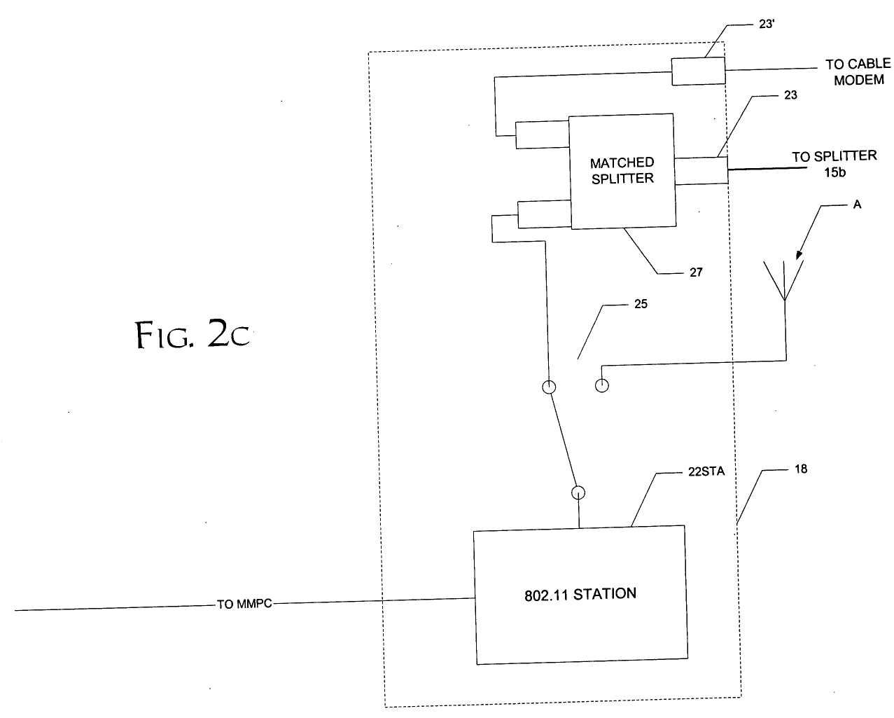

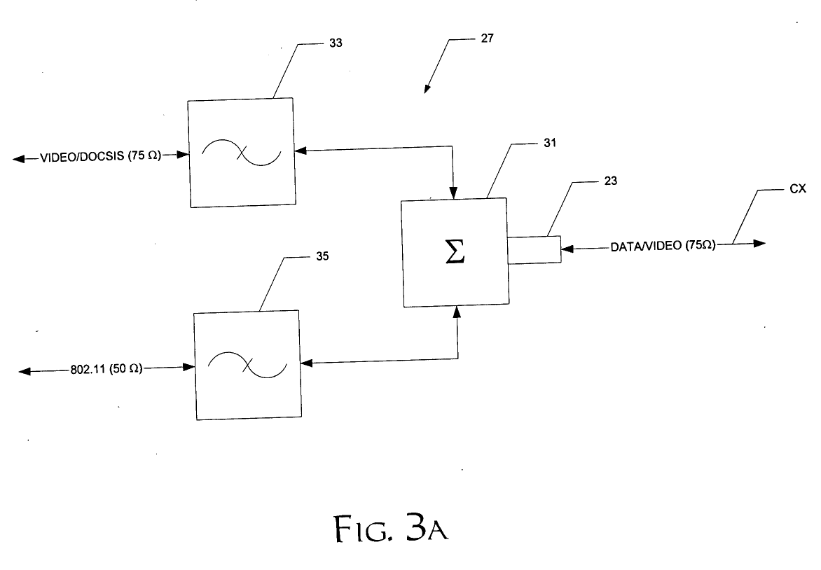

FIG. 2a illustrates, in more detail, the construction of main network station 10 in the home network of FIG. 1, according to the preferred embodiment of the invention. Main network station 10 includes coaxial connector 23, which receives coaxial cable CX, for example from home splitter 15a. Matched splitter 27 is connected to coaxial connector 23. For incoming (to main network station 10) traffic, matched splitter 27 splits the incoming signals by frequency, such that video signals are split from network traffic (i.e., 802.11 signals); for outgoing signals (from main network station 10), matched splitter 27 effectively sums two (or more) such signals received at its split input/output terminals, the summed signals occupying different frequency bands. The detailed construction of matched splitter 27 will be described in further detail below. In the example of main network station 10, one of the split input/outputs of matched splitter 27 is connected to STB/DVD/PVR processor 20, and the other is connected to function switch 25.

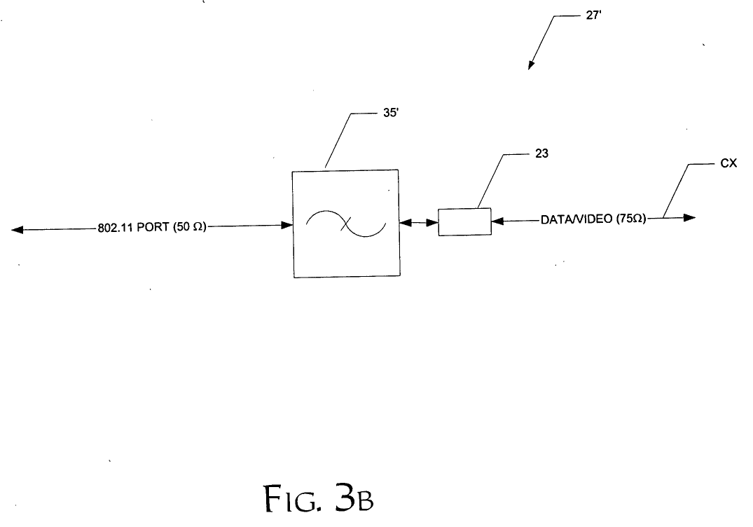

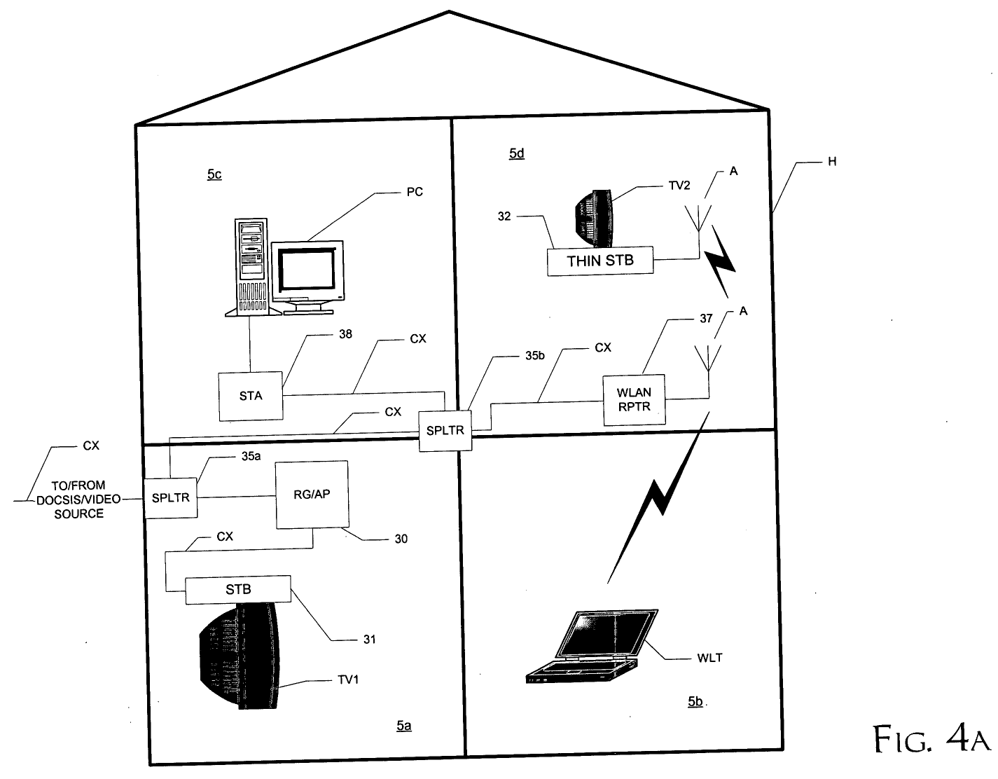

FIG. 3a illustrates, in block diagram form, the construction of matched splitter 27 according to the preferred embodiment of the invention. In this example, coaxial connector 23 is deployed in connection with summer 31, such that incoming signals from coaxial cable CX into matched splitter 27 are first applied to summer 31. In the incoming direction (into matched splitter 27 from coaxial cable CX), summer 31 has no effect, and as such the incoming signals are applied to both of filters 33 and 35. According to the preferred embodiment of the invention, the incoming signals on coaxial cable CX include television signals (and also DOCSIS standard data signals), which are at frequencies typically from about 5 MHz to about 860 MHz, and also include wireless protocol signals being locally communicated on the home network, which are at frequencies around 2400 MHz (for 802.11b/g) and around 5000 MHz (for 802.11a), according to the 802.11 standard wireless signals used in this embodiment of the invention. Filter 33 is a low-pass filter, which receives the full range of incoming signals on coaxial cable CX (i.e., from 5 MHz to about 5000 MHz), and filters out the high-frequency wireless protocol home network signals. The output of filter 33, coupled to STB/DVD/PVR processor 20, thus includes only the video (and DOCSIS data) signals, in the frequency band from about 5 MHz to 860 MHz, in this example. Conversely, filter 35 is a high-pass filter, also receiving the full frequency range of incoming signals but filtering out the lower frequency signals (i.e., at frequencies below about 1000 MHz). The output of filter 35 is connected to function switch 25 as shown in FIG. 2a, at which the wireless protocol local network signals at frequencies about 2400 MHz or about 5000 MHz, depending on the selected 802.11 substandard, are presented.

In the outgoing direction, filters 33, 35 also preferably operate to remove interference outside of their respective frequency ranges. In this example, filter 33 receives video signals, for example sourced by STB/DVD/PVR processor 20 for other television sets in the home (and perhaps DOCSIS data signals, as provided in data networks described below, which are modulated in the conventional manner as by a cable modem), and after filtering high frequency interference therefrom, applies the outgoing video (and DOCSIS data) signals to summer 31. Filter 35 receives wireless protocol signals, at the higher frequencies (e.g., about 2400 MHz or about 5000 MHz), filters out low frequency interference, and applies the filtered signal to summer 31. The wireless protocol signals may be either direct-sequence spread spectrum (DSSS) or orthogonal frequency division multiplexed (OFDM), depending on the network. Because the two inputs to summer 31, for outgoing traffic, are frequency division multiplexed (i.e., in different non-overlapping frequency bands), summer 31 may simply be provided by way of a wired-OR node (with impedance matching as described below). As such, the outgoing signals from matched splitter 27 onto coaxial cable CX include both video (and DOCSIS) signals in the lower frequency band (via filter 33) and higher frequency wireless protocol networking signals (via filter 35).

Filters 33, 35 may be implemented in the conventional manner, preferably by way of conventional analog filters. Alternatively, if desired, filters 33, 35 may be implemented as digital filters, but this realization would require analog-to-digital conversion and vice versa, perhaps becoming cost-inefficient. It is contemplated that analog filtering should be sufficient, as significant separation in frequency is present between the two bands in this example. It is contemplated that filters 33, 35 have an attenuation of <1 dB in the pass band, and >50 dB in the stop band. Preferably, the transmit spectral mask products of matched splitter 27, considering its filters, are less than −90 dB (relative to the maximum spectral density of the signal) in the video band (e.g., 5 to 860 MHz).

Especially at these high frequencies, matched splitter 27 preferably incorporates impedance matching at its input/output terminals, thus avoiding the attenuation and reflection issues that could otherwise be caused. In this example of the invention, coaxial cable CX is preferably a 75Ω coaxial cable, and as such coaxial cable 23 also preferably presents 75Ω input and output impedance. Similarly, the input/outputs at filters 33, 35 preferably match the impedance by their respective lines, for example also at 75Ω for video or television coaxial cable, and 50Ω for connection to an 802.11 port. It is contemplated that those skilled in the art having reference to this description can readily arrange matched splitter 27 to provide the appropriate impedances at its terminals.

As will become apparent from the following description, and as mentioned above, the external video (and data) source may be a satellite television provider, in which case the external video (and data) signals will be received by a satellite dish at or near the home. The characteristics of the filters in matched splitter 27 will be different in this case, because the satellite video signals will be communicated at frequencies up to about 2200 MHz. Low-pass filter 33 will be arranged to pass frequencies up to about 2200 MHz to communicate these video signals, while high-pass filter 35 will be arranged to block these higher frequency video signals.

In some cases, a three-port matching splitter 27 is not necessary, but the matching filtering function and protection is beneficial. Referring now to FIG. 3b, the construction of matching and protection filter 27′ will now be described. Matching and protection filter 27′ is contemplated to be useful for those network elements or stations in which only 802.11 over coaxial cable communications are to be supported (i.e., there is no cable television video signal, nor DOCSIS data to be communicated). In this example, matching and protection filter 27′ includes only high-pass filter 35′ connected between coaxial connector 23 presenting a 75Ω impedance matching that of coaxial cable, and a 50Ω terminal for connection to an 802.11 port. High-pass filter 35′ is designed to pass frequencies corresponding to the 802.11 wireless protocol (i.e., about 2400 MHz for 802.11b/g, and about 5000 MHz for 802.11a), and to reject other frequencies, including the lower frequencies at which cable television video signals, DOCSIS data, or even perhaps satellite video signals, are communicated.

Referring back to FIG. 2a, STB/DVD/PVR processor 20, as mentioned above, receives video and DOCSIS data signals from filter 33 in matched splitter 27, via line LF. STB/DVD/PVR processor 20 refers to one or more of the appropriate processing devices as used in conventional set-top boxes for performing these functions. In effect, STB/DVD/PVR processor 20 is preferably an advanced “set-top box” function, operating as a media server in the video home network. In this example, component video output (and accompanying audio output) is provided from STB/DVD/PVR processor 20 to a local television set or monitor, such as television set TV1 of FIG. 2. Another port of STB/DVD/PVR processor 20 is coupled to 802.11 access point 22, by way of a conventional bus or connection; in this example, STB/DVD/PVR processor 20 and access point 22 are connected by a conventional PCI bus.

The higher frequency output from matched splitter 27 is provided to on line HF to function switch 25 in main network station 10 according to this embodiment of the invention. With function switch 25 in its position as shown in FIG. 3a, these 802.11 packets are then forwarded to 802.11 access point 22. Access point 22 according to this embodiment of the invention is a conventional processor, such as the TNETW1130 single-chip MAC/baseband processor available from Texas Instruments Incorporated, in combination with an RF “front-end”, such as the RC2422 and RC2326 RF front end circuits (for 802.11b/g) or the RC2432 and RC2336 front end circuits (802.11a/b/g), all available from Texas Instruments Incorporated, which together perform the operation of converting received 802.11 packet-based communications to baseband digital data, and converting baseband digital data to 802.11 packet-based communications. In particular, the TNETW1130 processor is compatible with all versions (a/b/g) of the 802.11 standard, and is capable of applying and handling the security and QoS additions (e/i) to the 802.11 standard.

According to the preferred embodiments of the invention, access point 22 in main network station 10 serves as the “access point” for the communication of 802.11 packets over coaxial cable (and wirelessly, if desired). The other network elements will typically operate as “stations” on this 802.11 network, as will be described below. But of course, the “access point” function for the 802.11 over coaxial network need not necessarily reside at the main network station 10, but may be located at one of these other network elements, in which case access point function 22 of main network station 10 would instead operate as an 802.11 station. As known in the art, 802.11 station functionality is typically a subset of access point functionality, and as such can be readily configured in this manner.

In operation, digital video data sourced by STB/DVD/PVR processor 20 is converted into 802.11 packet communications by access point 22, and output via matched splitter 27 onto coaxial cable CX, for distribution over the home video network of FIG. 2. This permits video content from a DVD, or digitally recorded by a PVR, to be distributed in the form of 802.11 packets over coaxial cable CX to remote television set TV2, or to multimedia computer MMPC. And cable television content received from the external source and applied to processor 20 by matched splitter 27 can be forwarded by processor 20 to access point 22 for conversion into 802.11 packets, and then distributed back over coaxial cable CX to remote television set TV2. Conversely, video data in 802.11 packets sourced by multimedia workstation MMPC (e.g., home movies or digital still pictures stored at workstation MMPC) are received over coaxial cable CX at matched splitter 27 and routed to access point 22, are decoded by access point 22 into baseband digital data, and are then forwarded to STB/DVD/PVR processor 20 for display at television set TV1 in FIG. 1.

Referring back to FIG. 2a, main network station 10 also includes optional wireless access point capability, as provided by function switch 25 if switched to its other position so that access point 22 is connected to antenna A. It is contemplated that function switch 25 can be controlled in response to a user input or automatically, so that access point 22 can then support distribution of video signals wirelessly, for example to a client station or multimedia workstation in a neighboring room. Alternatively, to save manufacturing cost, the wireless capability can be eliminated by removing antenna A and function switch 25 from main network station 10.

Referring now to FIG. 2b, the construction of client network station 12, in the form of a “thin” set-top box, will now be described. Similar elements are referred to by the same reference numerals as in main network station 10 described above. As such coaxial cable CX is received by coaxial connector 23 at the input to matched splitter 27 in client network station 12. The lower frequency output of matched splitter 27 is not utilized by client network station 12 in this embodiment of the invention, considering that the “thin” set-top box driving television set TV2 receives only the 802.11 wireless protocol packets. The low frequency output on line LF may be connected to another coaxial connecter 23′, as shown in FIG. 2b, for example to communicate DOCSIS data to and from an optional cable modem, in a combination data/video network as will be described in further detail below.

The higher frequency output of matched splitter 27 is applied, on line HF, to station function 22 via function switch 25. Station function 22 STA operates as a conventional station in the 802.11 network, but of course receives its 802.11 packets over coaxial cable CX via matched splitter 27, rather than wirelessly as conventional. Station function 22STA may be implemented by way of a conventional processor, such as the TNETW1130 single-chip MAC/baseband processor available from Texas Instruments Incorporated, in combination with an RF “front-end”, such as the the RC2422 and RC2326 RF front end circuits (for 802.11b/g) or the RC2432 and RC2336 front end circuits (802.11a/b/g), all available from Texas Instruments Incorporated. In operation, station function 22STA converts the high frequency 802.11 packets into baseband digital data, and applies the same to thin STB processor 28 over a connection, such as a mini-PCI bus, a PCI bus, or an Ethernet link. Thin STB processor 28 in this embodiment of the invention includes video coder/decoder (“codec”) functionality, for driving a display device such as television set TV2, for example by way of component video cables. Conventional video codec devices may be used to realize thin STB processor 28, depending upon the attributes of the inputs required by television set TV2.

In operation, therefore, client network station 12 receives video signals, in the form of 802.11 packets, over coaxial cable CX from main network station 10, via splitters 15a, 15b. Matched splitter 27 of client network station 12 filters these packets and forwards them to station function 22STA of client network station 12, via function switch 25. Station function 22STA processes these packets into digital baseband data, and communicates this data to thin STB processor 28, which in turn decodes the digital data into video component signals, and applies the result to the display device (television set TV2).

As shown in FIG. 2b, function switch 25 may, alternatively, select antenna A as its input for wireless video data packets, in which case matched splitter 27 would be bypassed. Or if client network station 12 will only be operating in the coaxial mode, function switch 25 and antenna A may be eliminated, to save cost.

Referring now to FIG. 2c, the construction of network station 18 according to this preferred embodiment of the invention will be described. Network station 18 specifically provides support for 802.11 over coax networking, for the benefit of multimedia workstation MMPC, and as such may correspond to a card within multimedia workstation MMPC, or may instead be an external device.

In this regard, network station 18 is constructed similarly as client network station 12, except that there is no need for a video codec or other processing device, such processing being performed by multimedia computer MMPC itself. As such, network station 18 includes coaxial connector 23 connected to matched splitter 27. The lower frequency input/output of matched splitter 27 is again not necessarily utilized, although it may be connected, via line LF, to another coaxial connecter 23′ which in turn is connected to an optional cable modem in a combination data/video network.

The high frequency input/output terminal of matched splitter 27 is connected to station function 22STA via line HF and function switch 25. Station function 22STA is connected to multimedia workstation MMPC by way of a conventional bus, such as a mini-PCI bus, a PCI bus, or the like. Station function 22STA converts received high frequency 802.11 packets into baseband digital data, and converts baseband digital data from multimedia workstation MMPC into 802.11 packets. As such, multimedia workstation MMPC can receive 802.11 packets over coaxial cable CX via network station 18, and also communicate digital data, for example digital video or digital still picture data, as 802.11 packets over coaxial cable CX to other stations on the network, also via network station 18.

Again, function switch 25 may, alternatively, select antenna A as its input for wireless video data packets, in which case matched splitter 27 would be bypassed; however, if this wireless arrangement is to be made permanent, such a wireless access point is likely to be superfluous, considering the number of computers now that are shipped with built-in 802.11 wireless capability. Alternatively, to save cost, function switch 25 and antenna A may be eliminated if client network station 18 will only be operating in the coaxial mode.

According to this preferred embodiment of the invention, therefore, high data rate distribution of video throughout a home can be easily accomplished, using existing coaxial cable and at low cost. This distribution not only distributes incoming television content, but also permits the distribution of DVD or digitally stored video throughout the home, and also enables the distributing of multimedia digital content, such as digital home videos, digital still pictures, and the like from a multimedia computer to television sets elsewhere in the home. This video networking can be accomplished without requiring communication of data to and from the Internet, in this home video network context, and thus without the cost to the user of an Internet services contract.

Home Data and Video Network

According to another preferred embodiment of the invention, a home video and data network is provided, by way of which both video and data are networked throughout the home, including Internet downloads and uploads via an external data source.

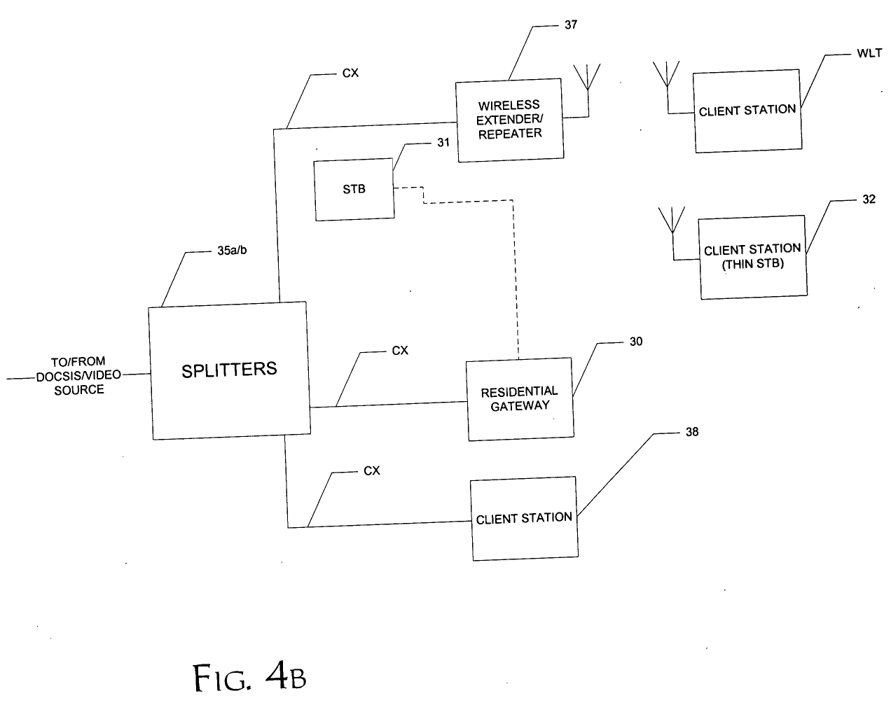

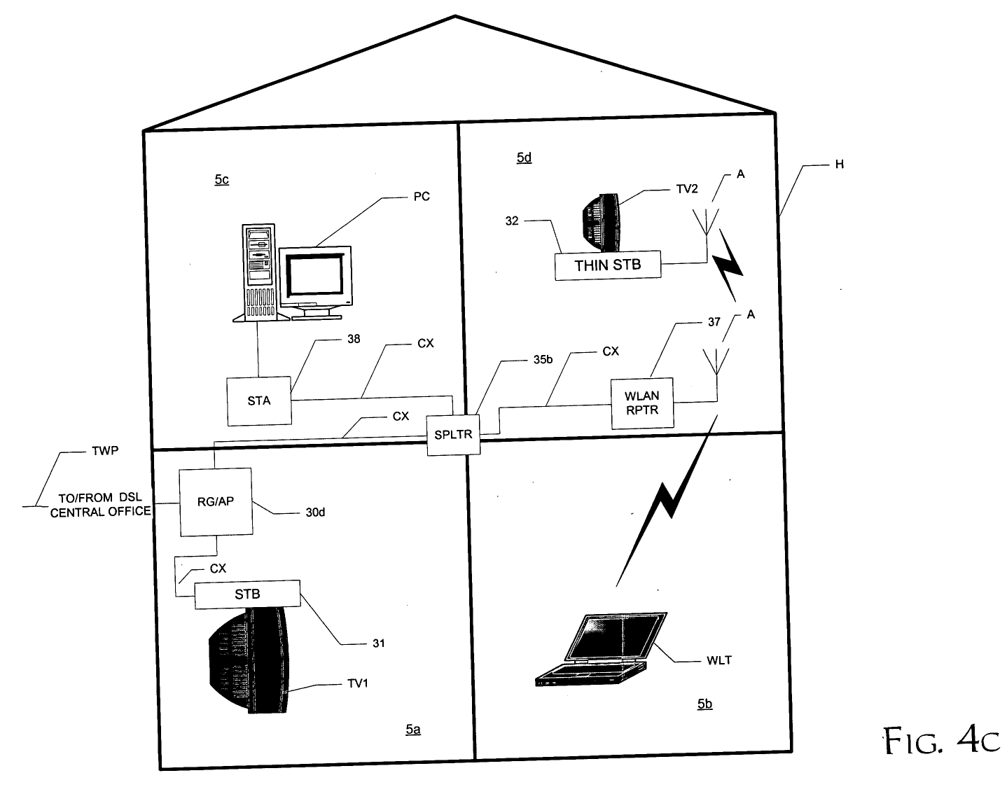

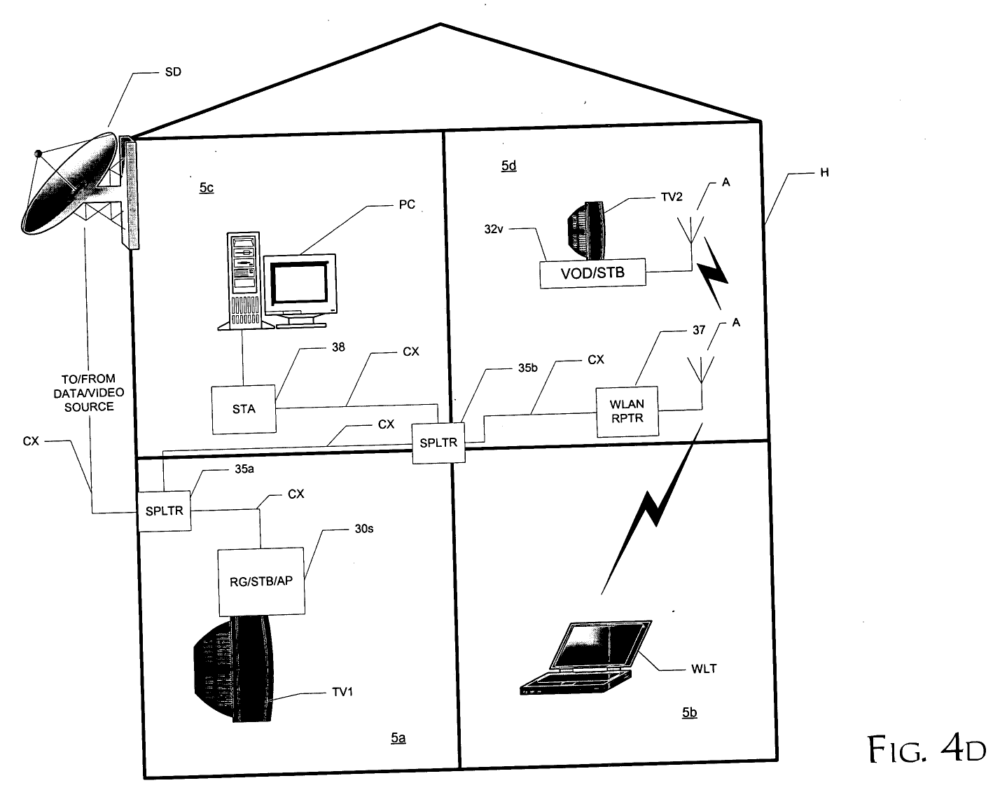

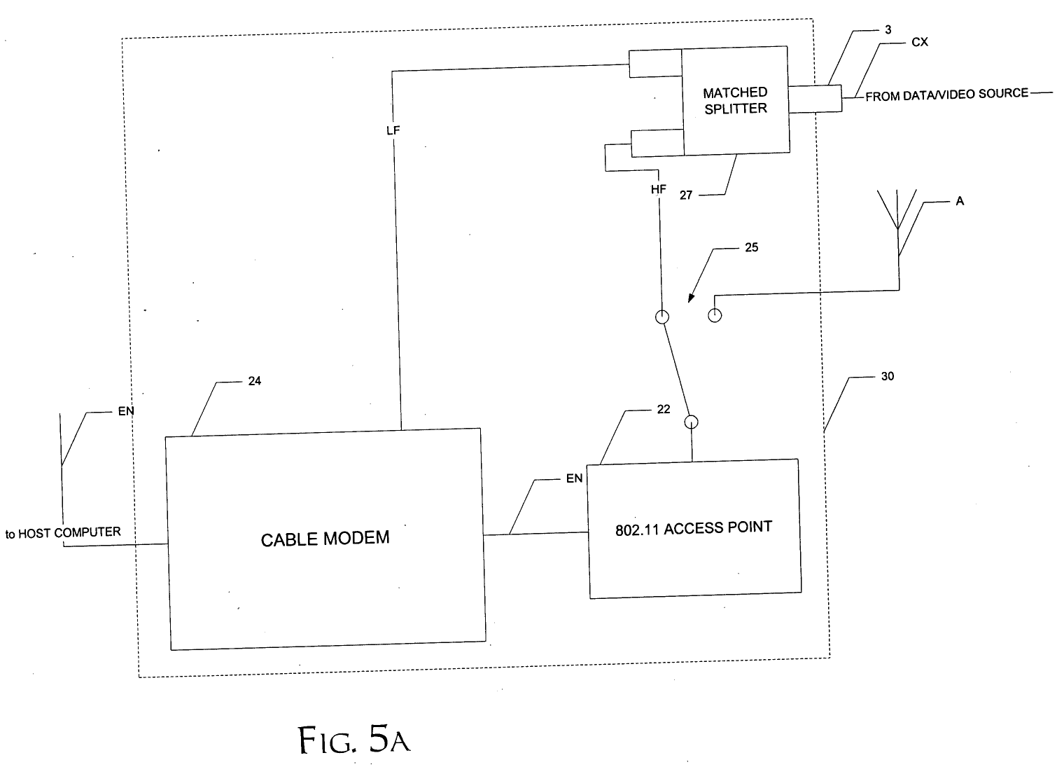

FIG. 4a illustrates an exemplary home local area network, itself and its components constructed according to the preferred embodiment of the invention. As is well-known in this art, the particular configuration of any given network depends upon the network elements involved, the structure and location of the various network elements, the types of connections desired, the number of users to be supported, and the like. Modem network equipment typically provides a great deal of flexibility to the network installer and users. As a result, the arrangement of home networks can vary widely. This particular home network installation shown in FIG. 4a is therefore presented by way of example only.

In the example of FIG. 4a, home splitter 35a connects the home to an external data and video source. This data and video source may be a cable television provider, providing data communication services according to the DOCSIS standard, and also providing conventional cable television programming, over a coaxial cable coming into the home. In this case, home splitter 35a will have, or be coupled to, a coaxial cable connector in order to connect to the cable television provider. Home splitters 35a, 35b are preferably conventional cable television splitters, as described above relative to home splitters 15a, 15b.

Alternative data and video sources are also contemplated. One alternative source is a satellite dish mounted to the home or nearby, by way of which data and television signals would be communicated from and to a satellite data and television provider, via a satellite in geosynchronous orbit, as well known in the art. Further in the alternative, the data and video source may be the central office of a telephone company, in which case the input connection may be a twisted-pair wire facility, or even a fiber optic facility, rather than coaxial cable.

Home splitter 35a receives the incoming cable that is coupled to the data and video source, and is coupled on another side to one or more network elements within the home, over coaxial cable CX according to this embodiment of the invention. It is contemplated that coaxial cable CX is coaxial cable that was already installed and present within the home at the time that the home network shown in FIG. 4a was arranged; for example in connection with the installation of cable television services throughout the home. The preferred embodiment of this invention is especially beneficial in this event, as it is capable of establishing a high data-rate home network without requiring new cabling to be installed. Of course, some or all of coaxial cable CX may be installed specifically in connection with the network deployment, as necessary or desirable.

In this example, residential gateway 30 is located in room 5a, and is connected to home splitter 35a by way of coaxial cable CX. Downstream from residential gateway 30 via coaxial cable(s) CX is set-top box (STB) 31, for tuning and receiving digital television programming for display on television set TV1. As will be described in further detail below, residential gateway 30 includes a cable modem (CM) function for effecting the modulating and demodulating of digital data to and from the external data source (e.g., Internet). Other functions such as a personal video recorder (PVR) for recording digital television programming and distributing it to television set TV1 and to other television sets and client stations on the network, may also be present in room 5a, or even incorporated into residential gateway 30 (for example, as described above relative to FIG. 2a). Preferably, residential gateway 30 manages network communications among the network stations within the home network. As will be described in further detail below, residential gateway 30 receives and processes both DOCSIS data signals and video signals over coaxial cable CX, and communicates over the home network via coaxial cable CX by way of 802.11 wireless protocol signals. Optionally, residential gateway 30 may also include an antenna and functionality for serving as a wireless access point (AP) for other network elements within its vicinity, such as wireless laptop computer WLT1 in neighboring room 5b.

In the exemplary home network installation shown in FIG. 4a, home splitter 35b is also connected to home splitter 35a by way of coaxial cable CX. Home splitter 35b is in turn connected by coaxial cable CX to client network station 38, which serves as an access point to desktop workstation PC in upstairs room 5c. Workstation PC may be provided for Internet access purposes (web browsing, email, instant messaging, and the like) and may have additional functions, such as distributing audio signals throughout the home, and distributing digital video signals to television sets TV1, TV2. Wireless LAN repeater (or extender) 37 is also connected by coaxial cable CX to home splitter 35b, and provides a wireless LAN access point, for example to wireless laptop computer WLT in room 5b and client network station 32, which in this case is a “thin” set-top box coupled to television set TV2 in upstairs room 5d. In addition, this network configuration can also support other devices, such other devices including, for example, a wireless portable video terminal.

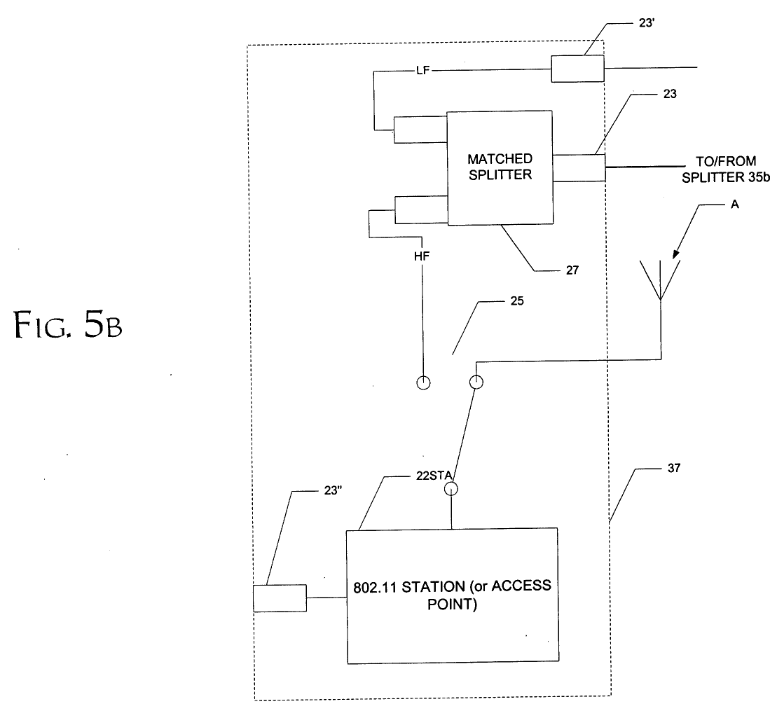

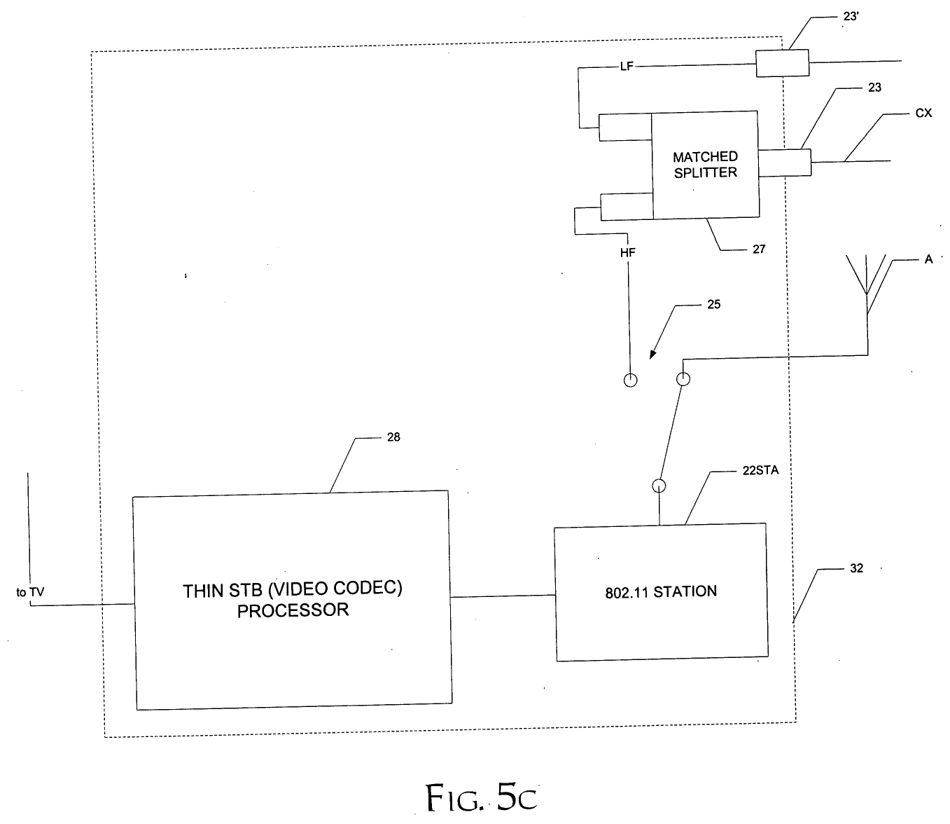

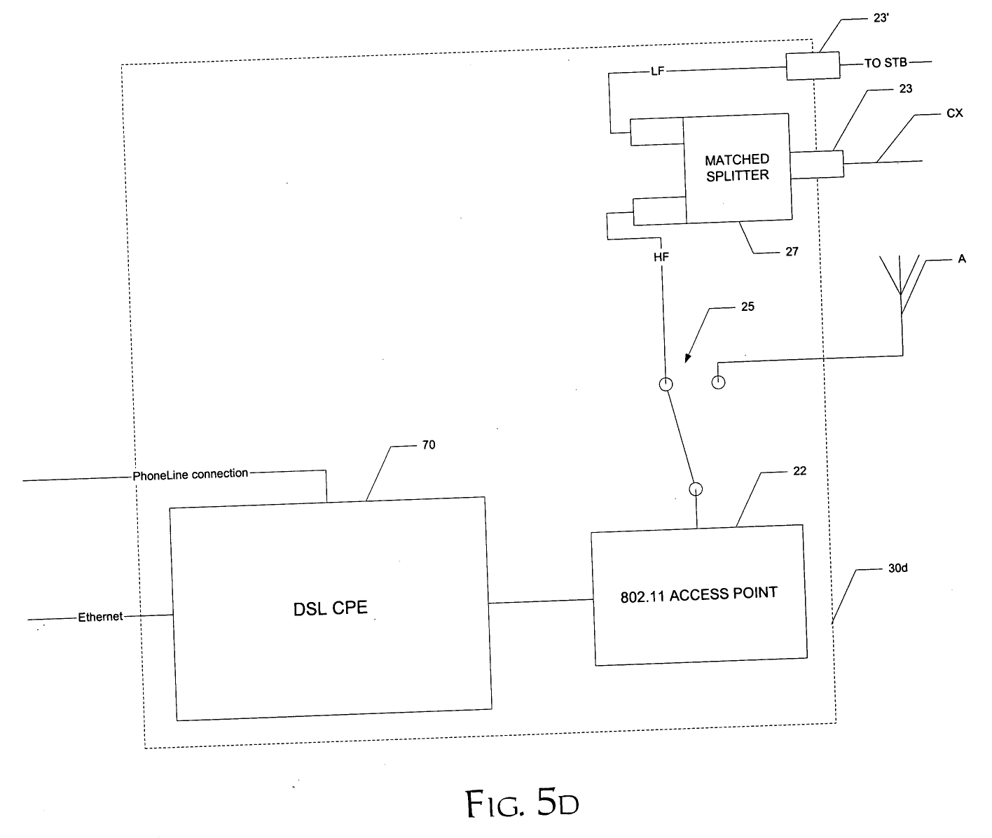

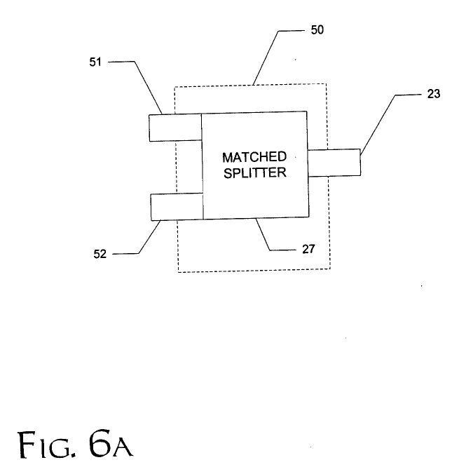

FIG. 4b illustrates, in block diagram form, the architectural arrangement of the home network of FIG. 4a. As shown in FIG. 5b, home splitters 35a/b distribute the connection to the data and video source among the stations in the home network, specifically over coaxial cable CX to residential gateway 30, to client network station 38, and to repeater 37. Residential gateway 30 serves as the residential gateway for the home network, receiving the incoming DOCSIS data and video signals and controlling the distribution of these signals over the home network. In this regard, residential gateway 30 operates its cable modem function, and converts data signals into 802.11 communication packets to be transmitted over the network, and conversely receives 802.11 communication packets from clients on the home network and generates the appropriate DOCSIS signals for transmission externally from the home. Optionally, residential gateway 30 may also receive signals from STB 31 by way of a PCI bus, Ethernet link, or the like, or even by way of 802.11 signals over coaxial cable or wirelessly (in the case where STB 31 supports 802.11 communication protocol) so that video information from STB 31 can be distributed over the network, also by way of 802.11 packets. Residential gateway 30 also preferably performs router-like or server functions, for routing local communications within the home network among the various stations, and for effecting such functions as printer and other resource sharing.

An architecture for the construction of residential gateway device 30 for supporting 802.11 wireless communications over coaxial cable will now be described, with reference to FIG. 5a. As shown in FIG. 5a, residential gateway 30 includes matched splitter 27 that is connected to coaxial cable CX from splitter 35a via coaxial connector 23. Through home splitter 35a, coaxial cable CX is coupled to the external data and video source, which is provided by the cable data and television provider external to the home network. The low frequency output from matched splitter 27 is connected to cable modem function 24 (and which may also be split off to forward incoming cable television signals to STB 31 for display), and the high frequency output from matched splitter 27 is connected to function switch 25.

Cable modem function 24 is a conventional cable modem, operating in connection with a conventional standard such as DOCSIS for the modulation and demodulation of digital signals to and from coaxial cable CX and thus the data source. Cable modem function 24 is connected, by way of Ethernet cable EN or the like, to a host computer, and also to wireless access point function 22. Wireless access point 22 is connected to function switch 25. In the switch position illustrated in FIG. 5a, access point function 22 effects bidirectional communication over coaxial cable CX via splitter 27 according to a wireless communication protocol (e.g., an operative one of the 802.11 standards). The other position of function switch 25 would couple access point 22 to antenna A, in which case it receives and transmits wireless packet data over a wireless link, and forwards this data to and from cable modem 24 over an Ethernet connection EN or the like. In either the coaxial or wireless case, data communications are carried out by access point 22 according to a wireless communications standard, in combination with cable modem function 24 as shown in FIG. 5a.

In the arrangement of FIG. 5a, as noted above, the high frequency input/output terminal of matched splitter 27 is connected to access point 22 via line HF and function switch 25. Access point 22 is connected to an input/output port corresponding to an Ethernet link EN, or alternatively a conventional bus, such as a mini-PCI bus, a PCI bus, or the like. Access point 22 converts received high frequency 802.11 packets received from splitter 35a into baseband digital data for application to cable modem 24 over Ethernet link EN; in turn, cable modem 33 converts that baseband digital data to DOCSIS signals, which are output via coaxial connector 23′, matched splitter 23, and splitter 35a. Conversely, demodulated digital data for distribution to a network element in the home network is received by access point 22 from cable modem 24 over Ethernet link EN, and access point 22 converts this data into 802.11 packets and outputs them over coaxial cable CX through matched splitter 27.

According to this preferred embodiment of the invention, residential gateway 30 may also operate in a dual-BSS mode, in which two separate BSSes are simultaneously supported. One BSS corresponds to the communication of 802.11 packets over coaxial cable (i.e., via matched splitter 27) and the other corresponds to the communication of 802.11 packets wirelessly, via antenna A. In this dual-BSS mode, function switch 25 alternately selects antenna A and matched splitter 27, in coordination with the packets transmitted (and to be received) by access point 22. Indeed, the operation of the dual BSSes may be carried out using different 802.11 protocols (e.g, 802.11b for one BSS, and 802.11g for the other). Alternatively, to save cost, function switch 25 and antenna A may be eliminated if client network station 12 will only be operating in the coaxial mode.

Alternatively, residential gateway 30 may include a built-in STB/DVD/PVR function, and would in this case be similarly constructed as main network station 10 of FIG. 3a, but also including the cable modem function 24.

As before, access point 22 in residential gateway 30 serves as the “access point” for the communication of 802.11 packets over coaxial cable (and wirelessly, if desired), and the other network elements will typically operate as “stations” on this 802.11 network. But of course, the “access point” function for the 802.11 over coaxial network need not necessarily reside at residential gateway 30, but may be located at one of these other network elements, in which case access point function 22 of residential gateway 30 would instead operate as an 802.11 station. As known in the art, 802.11 station functionality is typically a subset of access point functionality, and as such can be readily configured in this manner.

As shown in FIG. 4b, repeater 37 receives 802.11 packets over coaxial cable CX, and communicates these packets with wireless laptop computer WLT and client network station (thin STB) 32. Referring now to FIG. 5b, the construction of wireless repeater (or extender) 37 according to the preferred embodiment of the invention will now be described.

The external coaxial connector 23 of repeater 37 is connected to splitter 5b via coaxial cable CX. On its other side, the high frequency input/output terminal of matched splitter 27 is connected to station function 22STA via line HF and function switch 25. Station function 22STA is also connected to antenna A via function switch 25, and to an Ethernet connector 23″, for a network link if desired.

In operation, repeater 37 can operate in a dual BSS mode, with one BSS corresponding to the communication of 802.11 packets over coaxial cable (i.e., via matched splitter 27) and the other corresponds to the communication of 802.11 packets wirelessly, via antenna A. In this dual-BSS mode, function switch 25 alternately selects antenna A and matched splitter 27, in coordination with the packets transmitted (and to be received) by station function 22STA. In this dual BSS operational mode, station function 22STA is operable as an 802.11 station in one BSS (the 802.11 over coaxial BSS), and as an 802.11 access point in the second BSS (the wireless BSS). In these roles, station function 22STA can forward 802.11 packets received over coaxial cable CX (in one BSS) as 802.11 packets transmitted over antenna A, to wireless laptop WLT and client network station 32 in this example. Conversely, station function 22 STA is operable, in this dual BSS mode, to forward 802.11 packets received by antenna A, from wireless laptop WLT and client network station 32 in this example, as 802.11 packets transmitted over coaxial cable CX via matched splitter 27.

Referring now to FIG. 5c, client network station 32 is similarly constructed as station 12 described above relative to FIG. 3b, described above. But in this example, function switch 25 is controlled to select antenna A as the source of 802.11 packet data, as shown in FIG. 5c. Station function 22STA converts these 802.11 packets into baseband digital data, forwarding that data to thin STB processor 28, for display at television set TV2 in this example.

Alternatively, if desired, 802.11 packets for display at television set TV2 may be received over coaxial cable CX, rather than wirelessly over antenna A, by setting function switch 25 to its other position. Further in the alternative, client network station 32 may be operated in a dual BSS mode, in which case 802.11 packets can be received from either source.

Referring back to FIG. 4a, network station 38 connects workstation PC to the coaxial network. The construction of network station 38 corresponds to that of network station 18, described above relative to FIG. 2c. Again, network station 38 can also operate in a dual BSS mode, with its function switch 25 switching between the BSS corresponding to the 802.11 over coaxial link, and the BSS corresponding to the wireless network link.

To the extent that any of the network stations in the home network shown in FIGS. 4a and 4b operate in the wireless domain, or in a dual BSS mode including wireless communications, it is contemplated that network configuration and path choices can be made to determine whether a particular link between two stations is to be made over coaxial cable CX, a wireless link, or a combination of the two (and if so, the nature of that combination). As described in commonly assigned copending application Ser. No. 10/740,312, filed Dec. 18, 2003, through which this application claims priority, and which is incorporated herein by this reference, the decision how to transmit each packet may depend on the packet itself, on the location of the destination of the packet, or on both. The internal memory of a 802.11 access point 22 may store a table that defines the network stations that are coupled to the wireless connection, enabling the selection of the path over which to send a given packet from the contents of the table. For example, when a destination station identification is found in the table, the packet is sent via the wireless connection to the identified station; the table may also include an entry for each station that defines the transmit power for packets sent to that station, to minimize interference to stations connected via coaxial cable CX. The wireless station transmitter may also have a gain control element responsive to a control signal determined by the stored power value in the table. Alternatively, the table may also store values identifying the stations coupled to the coaxial cable, and thus similarly control coaxial communications.

Because, in most homes, the propagation loss of either the 802.11b/g or the 802.11a signal (in 2.4 GHz or 5 GHz respectively) is lower over coaxial cable than over the air, due to the attenuation of walls, floors, and other structural features, the use of coaxial cable CX to carry wireless protocol transmissions extends the reach and expands the coverage of the home network by bypassing high-loss wireless paths with a low-loss coaxial path, or hybrid coaxial/wireless path. If an all-coaxial path can be used, the communications are particularly of high quality, allowing reliable operation at high throughput modes of 802.11a/g (54 Mbps).

Alternatively to this coaxial home network, the home may receive its television programming and data services over the Public Switched Telephone Network (PSTN) by way of Digital Subscriber Line (DSL) technology, yet the resident may wish to implement an 802.11 over coaxial home network compatible with such an external source. In this case, the residential gateway may include a built-in DSL modem function to support, for example, a home network in which the external video and data source is a DSL service provider, as will now be described with reference to FIG. 4c. As evident in this example, the external data and video source is the central office of a telephone company, through which the DSL service provider (which may be the telephone company itself or another provider forwarding its services through the telephone company) communicates data to and from the home via twisted-pair wire facility TWP. Twisted-pair facility TWP may interface with a fiber optic network at or near the home, as known in the art.

In this embodiment of the invention, DSL residential gateway 30d is connected to receive twisted-pair facility TWP, and includes a conventional DSL modem function for modulating signals for transmission and demodulating signals received over twisted-pair facility TWP. FIG. 5d illustrates the construction of DSL residential gateway 30d, in this example. As shown in FIG. 5d, residential gateway 30d is constructed similarly as residential gateway described above relative to FIG. 5a, except that DSL client premises equipment (CPE) 70 are included within gateway 30d, instead of the cable modem function, described above. In this example, incoming external data signals would be demodulated by DSL CPE 70, and forwarded as baseband digital data to access point function 22, which in turn will arrange these output signals into the appropriate wireless communications protocol (e.g., according to one of the 802.11 standards) and transmit these signals over coaxial cable CX via function switch 25 and matched splitter 27; incoming wireless packet signals over coaxial cable CX are converted to baseband by access point 22 and forwarded to DSL CPE 70 over Ethernet link EN for eventual communication to the external data source over twisted pair facility TWP. Function switch 25 may alternatively be controlled to select antenna A as the source and destination of 802.11 packet data, as shown in FIG. 5d.

In another embodiment of the invention, residential gateway 30 (or residential gateway 30d of FIG. 5d) may be replaced by an external standalone Cable Modem or DSL CPE in combination with an 802.11 wireless/over coax access point. Such an 802.11 access point would communicate with the cable modem or CPE by way of an Ethernet link, or another conventional approach. The 802.11 access point in this alternative implementation would be constructed similarly as repeater 37 of FIG. 5b, with station function 22STA operating as an 802.11 access point. In this example, incoming external data signals would be demodulated by the external standalone cable modem or DSL CPE, and forwarded as baseband digital data to access point function 22STA (via connector 23″ of FIG. 5b); station function 22STA will in turn arrange these digital data into the appropriate wireless communications protocol (e.g., according to one of the 802.11 standards) and transmit these signals over coaxial cable CX via function switch 25 and matched splitter 27. Incoming wireless packet signals received over coaxial cable CX are converted to baseband by station function 22STA (as an access point) and forwarded to other devices such as external standalone cable modem or DSL CPE over Ethernet link EN for eventual communication to the external data source. Alternatively, function switch 25 may be controlled to select antenna A as the source and destination of 802.11 packet data, as shown in FIG. 5b.

Referring to FIG. 4d, a home network according to an alternative arrangement, in which the external data and video source is a satellite transmitter, to and from which data and video signals are received over satellite dish SD, and communicated by coaxial cable CX, will now be described. The incoming coaxial cable CX is received at home splitter 35a, which is connected to residential gateway 30s over coaxial cable CX. The construction of residential gateway 30s is similar to that of residential gateway 30 of FIG. 5a, with the exception that a different type of demodulation may be required for satellite data signals, in place of cable modem function 24. It is contemplated that those skilled in the art will be readily able to arrange residential gateway 30s from this description.

Of course, the arrangement of network elements within the home network may vary widely, depending on the user requirements, from those shown in FIGS. 4a through 4d. It is contemplated that those skilled in the art having reference to this specification will be readily able to configure such desired networks.

These and other alternative implementations are contemplated to be useful within the context of the home network utilizing 802.11 over coaxial communication.

Therefore, according to the preferred embodiments of the invention, a relatively complex network can be readily implemented, using wireless network technology in combination with existing coaxial cabling within the home. Both video (cable television, digital video and still pictures, etc.) and data (including shared Internet access, printer and other resource sharing, etc.) can be readily networked in this manner. It is also contemplated that this home networking will also allow the networked control and operation of other services, including high-fidelity audio, home appliances, security systems, and the like. Voice over Internet Protocol (VoIP) telephony can also be included within such a network. In addition, the use of modem wireless communications standards (e.g., 802.11 wireless) provide high data rate capability, especially if the wireless distance is minimized by the provision of coaxial wireless repeaters and extenders, enabling a great deal of functionality and performance.

Upgrade Kits

According to another embodiment of the invention, existing network elements and equipments can be readily upgraded or adapted for use on the 802.11 over coaxial networks described herein. More specifically, it is contemplated that existing wireless network elements can be readily adapted to be connected into the 802.11 over coaxial network, as will now be described relative to FIGS. 7a through 7c.

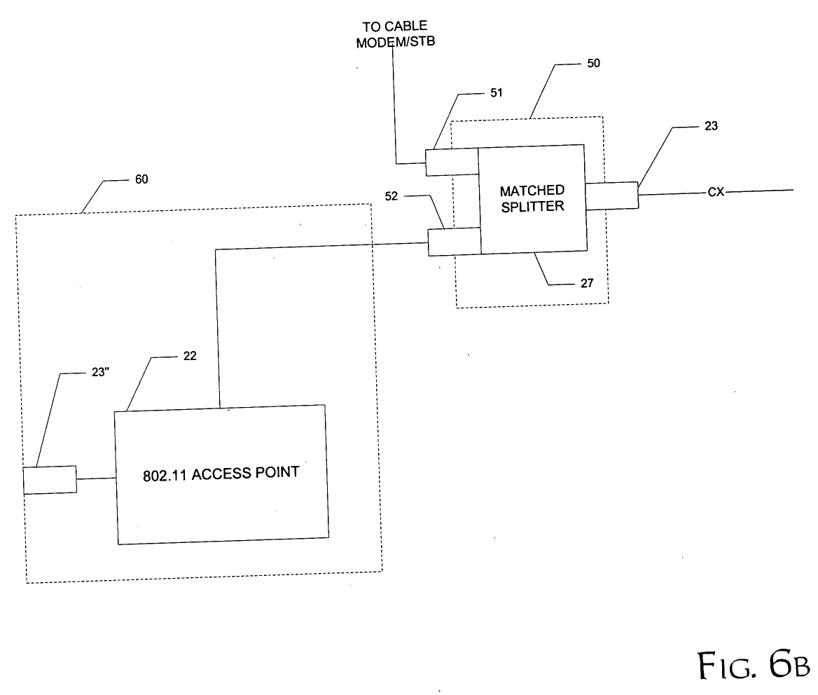

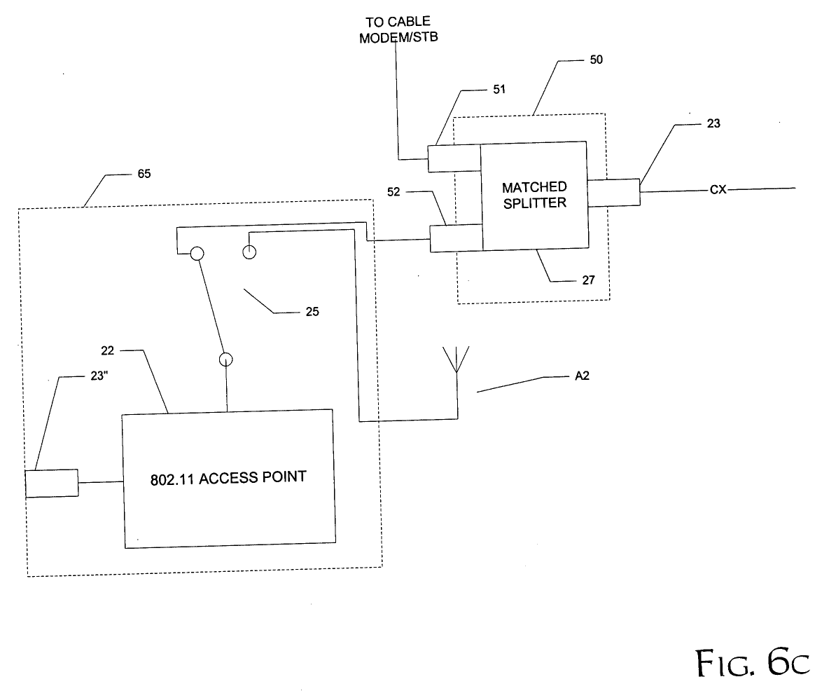

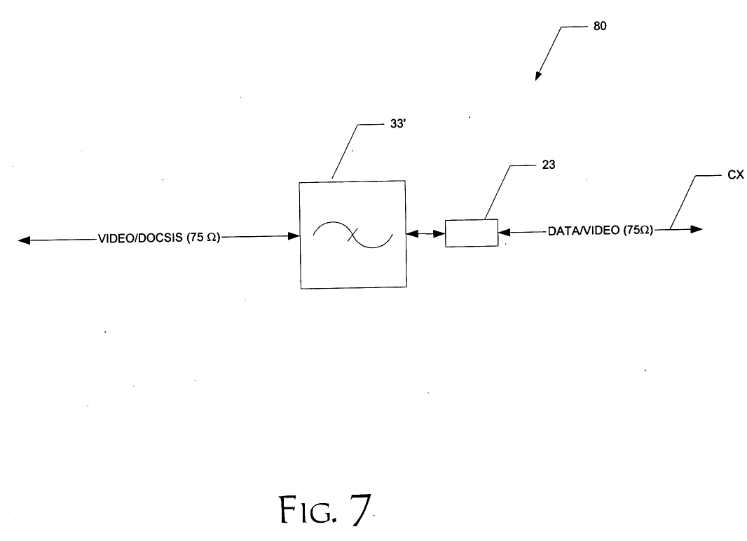

FIG. 6a illustrates upgrade device 50, which can be connected to the coaxial network and to an existing wireless network element. Upgrade device 50 includes coaxial connector 23, for connecting to coaxial cable CX in the coaxial network. Coaxial connector 23 is connected to matched splitter 27, which is constructed in the manner described above relative to FIG. 4. The lower frequency input/output of splitter 27 is connected to coaxial connector 51, as before, which may be connected to a cable modem, set-top box, or other device capable of receiving or communicating DOCSIS data or conventional cable television signals. On the higher frequency side, upgrade device 50 includes antenna connector 52, which can connect directly, or by way of a cable, to an wireless antenna connector of a wireless network element, such as a wireless access point, router, wireless network card in a computer, or the like.

FIG. 6b illustrates single antenna wireless network device 60, to which upgrade device 50 is attached according to a preferred embodiment of the invention. As shown in FIG. 6b, connector 23 of upgrade device 50 is connected to coaxial cable CX, and thus into the home network. Antenna connector 52 of upgrade device 50 is connected to the antenna output of network device 60, with the physical connection made either directly or by way of a preferably short cable, and is thus electrically connected to 802.11 access point function 22 of network device 60. Access point 22 is electrically connected, for example by way of an Ethernet link, or a PCI bus, or the like, via connector 23″ (or another conventional way) to the host device to which network device 60 serves. This host device may, of course, be a personal computer workstation, laptop computer, or the like.

The operation of access point function 22 to communicate over coaxial cable CX via upgrade device 50 does not change from its operation in communicating wirelessly. Insofar as access point 22 is concerned, and therefore insofar as its host device is concerned, the 802.11 communications operations are identical between coaxial and wireless links. Accordingly, no software or other operational changes are required for network device 60 to communicate over coaxial cable CX—only the physical connection via upgrade device 50 rather than to an antenna need be made.

FIG. 6c illustrates the connection of upgrade device 50 to a dual antenna network device 65, according to another preferred embodiment of the invention. Network device 65 has two external connectors to antennae, one of which is now connected to antenna connector 52 of upgrade device 50, and the other of which remains connected to antenna A2. Network device 65 also includes function switch 25, either originally or added by way of further upgrade, which selects whether access point function 22 is connected to upgrade device 50 and thus coaxial cable CX for 802.11 over coaxial networking, or to wireless antenna A2 for conventional 802.11 wireless communications. This selection may remain fixed, in a single BSS mode, in which case the operation of access point function 22 need not change in any way to effect 802.11 over coaxial network communications.

Alternatively, network device 65 may operate in a dual BSS mode, in which one BSS corresponds to the 802.11 over coaxial network via upgrade device 50, and the other BSS corresponds to the wireless communications over antenna A2. In this case, software configuration of function switch 25, and implementation of dual BSS operation in combination with switch 25, will likely be required. It is contemplated that those skilled in the art having reference to this specification will be readily able to implement these necessary changes.

From FIGS. 6a through 6c, it is evident that existing wireless network stations can be readily and economically upgraded to participate in 802.11 over coaxial network communications. The important advantages of extending wireless networking throughout the home can, as a result, be added to existing wireless networks without undue expense or installation work.

Protection Filter for Existing Devices

According to another embodiment of the invention, existing and conventional network elements and equipment that are already connected to existing home coaxial cabling may need protection when the home coaxial network is used for 802.11 over coaxial networks described herein. More specifically, it is contemplated that existing network elements can be readily protected, as will now be described relative to FIG. 7.

Referring now to FIG. 7, the construction of protection filter 80 for an existing device will now be described. Protection filter 80 is contemplated to be useful for those network elements, typically pre-existing devices, in which only the cable television video signal or DOCSIS data are to be supported (i.e., that will not receive or transmit 802.11 over coaxial cable data). In this example, protection filter 80 for existing devices includes only low-pass filter 33′ connected between coaxial connector 23 presenting a 75Ω impedance matching that of coaxial cable, and a 75Ω terminal for connection to an existing device such as a television set, digital set-top box and the like. Low-pass filter 33′ is designed to reject frequencies corresponding to the 802.11 wireless protocol (i.e., about 2400 MHz for 802.11b/g, and about 5000 MHz for 802.11a), and to pass other frequencies, including the lower frequencies at which cable television video signals, DOCSIS data, or even perhaps satellite video signals, are communicated.

### CONCLUSION

According to the preferred embodiments of the invention, therefore, a home network for communication of video signals, or of video signals in combination with digital data and Internet access, can be readily installed, using existing coaxial cabling in the home. High data rate communications are thus enabled throughout the home, and the range and coverage of wireless communications are extended and expanded, again without requiring the installation of new cabling.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

1. A home network, comprising:
coaxial cable;
a first network station, comprising:
a first coaxial connector coupled to coaxial cable;
a matched splitter, connected to the coaxial connector on one side, and on another side having first and second terminals; and
a wireless communications access point, coupled to a first terminal of the matched splitter, for processing wireless protocol communications for transmission and as received over the coaxial cable via the matched splitter; and
a second network station, comprising:
a coaxial connector coupled to coaxial cable;
a wireless communications station, coupled to the coaxial connector, for processing wireless protocol communications for transmission and as received over the coaxial cable via the matched splitter.

2. The network of claim 1, wherein the first network station further comprises:
a modem, coupled to the second terminal of the matched splitter, for demodulating data signals received over the coaxial cable and for providing digital data corresponding to the demodulated data signals to the wireless communications access point, and for modulating data signals received from the wireless communications access point and transmitting the modulated data signals over the coaxial cable.

3. The network of claim 2, wherein the modem is a cable modem.

4. The network of claim 2, wherein the modem comprises DSL customer premises equipment.

5. The network of claim 1, wherein the first network station further comprises:
a video processing function, coupled to the second terminal of the matched splitter, for receiving and processing television signals received over the coaxial cable.

6. The network of claim 5, wherein the wireless communications access point of the first network station is coupled to the video processing function;
and wherein the wireless communications access point is for converting wireless protocol communications to baseband digital data and forwarding the baseband digital data to the video processing function.

7. The network of claim 6, wherein the wireless communications access point is for converting baseband digital data from video processing function to wireless protocol communications and forwarding the wireless protocol communications to the coaxial cable.

8. The network of claim 7, wherein the second network station further comprises:
a video codec, coupled to the wireless communications access point;
and wherein the wireless communications station is for converting wireless protocol communications to baseband digital data and forwarding the baseband digital data to the video codec.

9. The network of claim 8, further comprising:
a video display, coupled to the video codec.

10. The network of claim 1, wherein the first network station further comprises:
an antenna; and
a function switch, for selectively coupling the wireless communications access point to the first terminal of the matched splitter or the antenna.

11. The network of claim 1, wherein the matched splitter comprises:
a first filter, coupled between the coaxial connector and the first terminal, for filtering frequencies in a first stop band;
a second filter, coupled between the coaxial connector and the second terminal, for filtering frequencies in a second stop band.

12. The network of claim 11, wherein the first network station further comprises:
a modem, coupled to the second terminal of the matched splitter, for demodulating data signals received over the coaxial cable and for providing digital data corresponding to the demodulated data signals to the wireless communications access point, and for modulating data signals received from the wireless communications access point and transmitting the modulated data signals over the coaxial cable.

13. The network of claim 11, wherein the first network station further comprises:
a video processing function, coupled to the second terminal of the matched splitter, for receiving and processing television signals received over the coaxial cable.

14. The network of claim 13, wherein the video processing function comprises a processor for processing video signals for a function selected from the group consisting of a set-top box, a digital video disk player, and a personal video recorder.

15. The network of claim 1, wherein the second network station further comprises:
an antenna; and
a function switch, for selectively coupling the wireless communications station to the first terminal of the matched splitter or the antenna.

16. The network of claim 15, further comprising:
a client station, for communicating wirelessly to the second network station.

17. The network of claim 1, further comprising:
a multimedia workstation, coupled to the wireless communications access point of the second network station.

18. The network of claim 17, wherein the wireless communications station is for converting wireless protocol communications to baseband digital data and forwarding the baseband digital data to the multimedia workstation.

19. A network station for communicating wireless protocol communications over coaxial cable, comprising:
a first coaxial connector for coupling to coaxial cable;
a matched splitter, connected to the coaxial connector on one side, and on another side having first and second terminals;
a first filter, coupled between the coaxial connector and the first terminal, for filtering frequencies in a first stop band;
a second filter, coupled between the coaxial connector and the second terminal, for filtering frequencies in a second stop band; and
a wireless communications function, coupled to a first terminal of the matched splitter, for processing wireless protocol communications for transmission and as received via the matched splitter.

20. The network station of claim 19, further comprising:
a modem, coupled to the second terminal of the matched splitter, for demodulating data signals received from the first coaxial connector and for providing digital data corresponding to the demodulated data signals to the wireless communications function, and for modulating data signals received from the wireless communications function and transmitting the modulated data signals over the coaxial cable.

21. The network station of claim 20, wherein the modem is a cable modem.

22. The network station of claim 20, wherein the modem comprises DSL customer premises equipment.

23. The network station of claim 19, further comprising:
a video processing function, coupled to the second terminal of the matched splitter, for receiving and processing television signals received over the coaxial cable.

24. The network station of claim 23, wherein the wireless communications function of the first network station is coupled to the video processing function;
and wherein the wireless communications function is for converting wireless protocol communications to baseband digital data and forwarding the baseband digital data to the video processing function.

25. The network station of claim 24, wherein the wireless communications function is for converting baseband digital data from video processing function to wireless protocol communications and forwarding the wireless protocol communications to coaxial cable via the coaxial connector.

26. The network station of claim 24, wherein the video processing function comprises a processor for processing video signals for a function selected from the group consisting of a set-top box, a digital video disk player, and a personal video recorder.

27. The network station of claim 19, wherein the second network station further comprises:
a video codec, coupled to the wireless communications access point;
and wherein the wireless communications function is for converting wireless protocol communications to baseband digital data and forwarding the baseband digital data to the video codec.

28. The network station of claim 19, further comprising:
an antenna; and
a function switch, for selectively coupling the wireless communications function to the first terminal of the matched splitter or the antenna.

29. The network station of claim 28, wherein the network station operates in a dual-BSS mode;
wherein the function switch selective couples the wireless communications function to the first terminal of the matched splitter or the antenna synchronously with the dual-BSS operation.

30. A matched video and data splitter, comprising:
a first coaxial connector for connecting to coaxial cable;
a first filter, coupled between the coaxial connector and a first terminal, for filtering frequencies in a first stop band; and
a second filter, coupled between the coaxial connector and a second terminal, for filtering frequencies in a second stop band.

31. The splitter of claim 30, further comprising:
a second coaxial connector at the first terminal.

32. The splitter of claim 30, further comprising:
an antenna connector at the second terminal, for connecting to an antenna connector of a wireless network device.

33. The splitter of claim 30, wherein the first coaxial connector presents a matched impedance to coaxial cable.

34. The splitter of claim 33, further comprising:
a second coaxial connector at the first terminal;
and wherein the second coaxial connector presents a matched impedance to coaxial cable.

35. A network filter, comprising:
a first coaxial connector for connecting to coaxial cable, and having an impedance matching that of the coaxial cable;
a high pass filter, coupled between the coaxial connector and a first terminal, for filtering frequencies in a stop band corresponding to television signals and data signals corresponding to those communicated by a television signal provider, and passing frequencies in a pass band at frequencies higher than those of the stop band; and
a second connector coupled to the high pass filter.

36. The network filter of claim 35, wherein the second connector is an antennal connector, for connecting to an antenna connector of a wireless network device.

37. The network filter of claim 36, wherein the second connector presents a matched impedance to the antenna connector of the wireless network device.

38. The network filter of claim 35, wherein the television signal provider is a cable television provider.

39. The network filter of claim 35, wherein the television signal provider is a satellite television provider.

40. A protection filter, comprising:
a first coaxial connector for connecting to coaxial cable, and having an impedance matching that of the coaxial cable;
a low pass filter, coupled between the coaxial connector and a first terminal, for filtering frequencies in a stop band, and passing frequencies in a pass band at frequencies lower than those of the stop band and corresponding to television signals and data signals corresponding to those communicated by a television signal provider; and
a second connector coupled to the high pass filter.

41. The protection filter of claim 40, wherein the second connector is a coaxial cable connector, and presents an impedance matching that of coaxial cable.

42. The protection filter of claim 40, wherein the television signal provider is a cable television provider.

43. The protection filter of claim 40, wherein the television signal provider is a satellite television provider.
